(19) United States
(12) Patent Application Publication
(10) Pub. No.: US 2012/0115365 A1
(43) Pub. Date: May 10, 2012

(54) ELECTRICAL CONNECTOR WITH AN IMPROVED OUTER COVER

(75) Inventors: YI ZHOU, Kunshan (CN); FENG CHEN, Kunshan (CN); CHUNG-YEN YANG, New Taipei (TW)

(73) Assignee: HON HAI PRECISION INDUSTRY CO., LTD., New Taipei (TW)

(21) Appl. No.: 13/290,148

(22) Filed: Nov. 7, 2011

(30) Foreign Application Priority Data
Nov. 5, 2010 (CN) 201020593500.8

(51) Int. Cl. H01R 13/40

(52) U.S. Cl. 439/625

(57) ABSTRACT

An electrical connector, comprising: a mating portion, a cable electrically connected to the mating portion, an inner molding molded on a rear end of the mating portion and a front end of the cable, an outer cover assembled on the inner molding and enclosing the front portion of the inner molding and an outer molding enclosing the rear portion of the inner molding and attached to the outer cover. The inner molding defines a front portion located on a front end thereof, a rear portion located on a rear end thereof and a groove between the front portion and the rear portion.

### FIELD OF THE INVENTION

The present invention relates to an electrical connector, and more particularly to an electrical connector with an outer cover retaining on an inner molding thereof.

### DESCRIPTION OF PRIOR ART

Recently, a RCA connector usually defines an outer cover behind a mating portion thereof. The outer cover is played a role of insulation and protection. The outer cover is connected to the mating portion with a method which is molded or assembled on the mating portion.

U.S. Pat. No. 6,203,370, issued on Mar. 20, 2001, disclosed an electrical connector defining a connector body, a flexible O-ring and a shell. The connector body has a pin at a first end thereof and an outside threaded portion at a rear end thereof. The pin electrically insulates from the connector body and has an exterior surface at the first end. The connector body also defines a shoulder between the exterior surface and the threaded portion. The O-ring disposed over the threaded portion adjacent to the shoulder. The shell has an inside threaded end having an edge for threadably engaging the outside threaded portion of the connector body, adjacent to the O-ring. The O-ring is compressed when the shell is screwed onto the threaded portion of the connector body. The O-ring thereby provides increased friction between the connector body and the shell for resisting unscrewing forces. However, manufacturing the outside and inside threaded portion is complex, it may be increased the cost of production. When one of the threaded portions is broken, the shell can not be connected to the connector body, and the electrical connector can not be used.

As discussed above, an improved electrical connector overcoming the shortages of existing technology is needed.

### SUMMARY OF THE INVENTION

Accordingly, an object of the present invention is to provide an electrical connector with an outer cover retaining on an inner molding easily and conveniently.

In order to achieve the above-mentioned objects, an electrical connector comprises a mating portion, a cable electrically connected to the mating portion, an inner molding molded on a rear end of the mating portion and a front end of the cable, an outer cover assembled on the inner molding and enclosing the front portion of the inner molding and an outer molding enclosing the rear portion of the inner molding and attached to the outer cover. The inner molding defines a front portion located on a front end thereof, a rear portion located on a rear end thereof and a groove between the front portion and the rear portion.

Other objects, features and advantages of the invention will be apparent from the following detailed description taken in connection with the accompanying drawings.

### BRIEF DESCRIPTION OF THE DRAWINGS

FIG. 1 is a perspective view of an electrical connector in accordance with the present invention;

FIG. 2 is an exploded, perspective view of the electrical connector shown in FIG. 1;

FIG. 3 is a view similar to FIG. 2, from another aspect; and

FIG. 4 is a cross section view of the electrical connector of FIG. 1 taken along line 4-4.

### DETAILED DESCRIPTION OF PREFERRED EMBODIMENTS

Reference will now be made to the drawing figures to describe the present invention in detail.

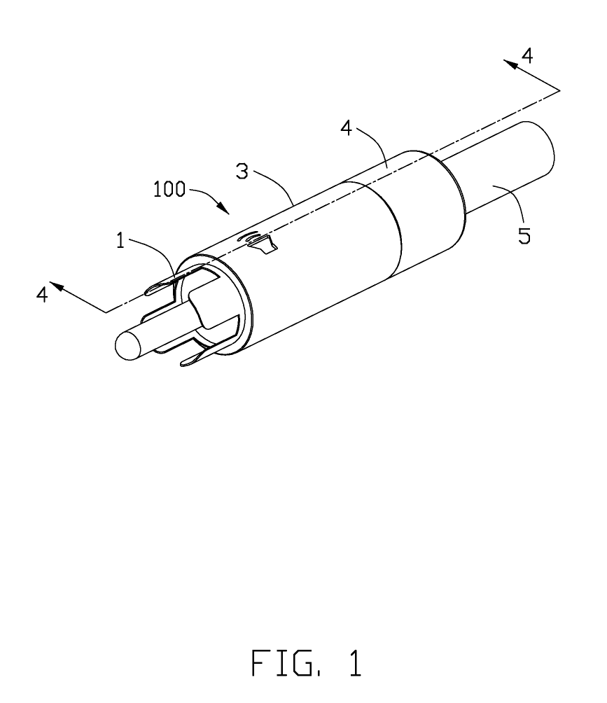

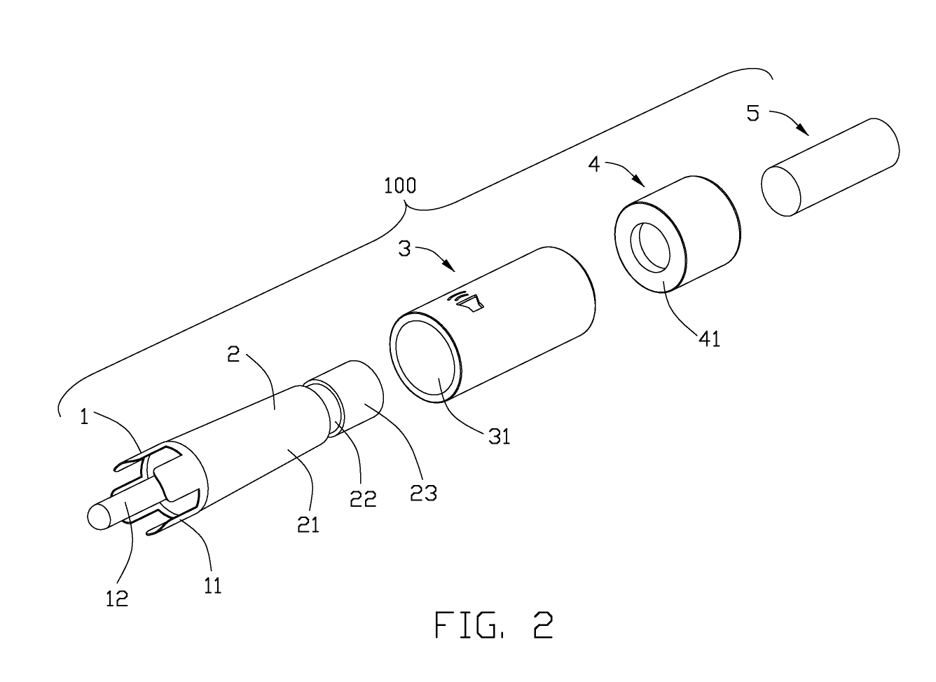

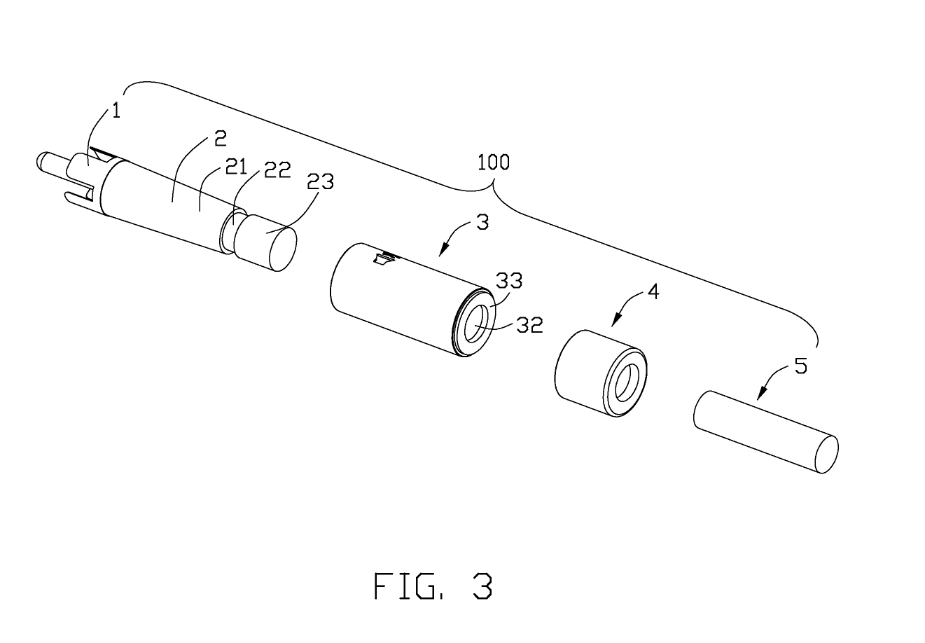

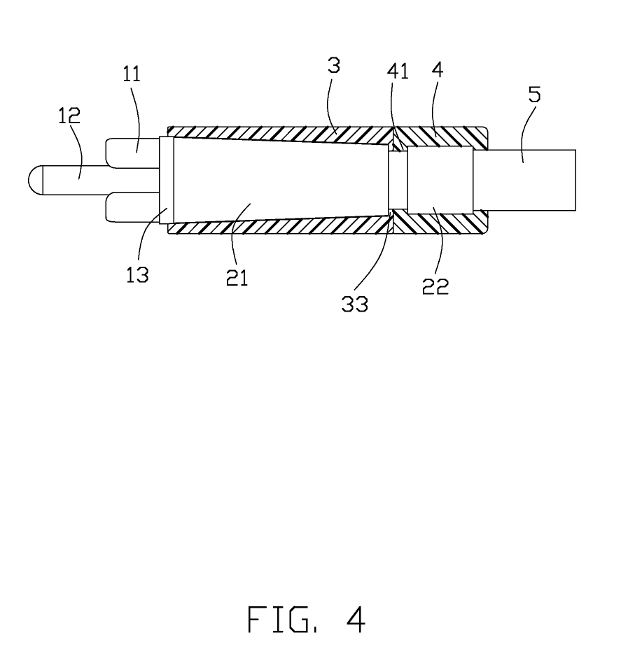

Referring to FIG. 1 to FIG. 4, an electrical connector 100 in accordance with the present invention comprises a mating portion 1, an inner molding 2 located behind the mating portion 1, an outer cover 3 assembled on the inner molding 2, an outer molding 4 located behind the outer cover 3 and a cable 5 electrically connected to the mating portion 1.

The mating portion 1 comprises a main portion 11, a pin 12 electrically insulated and surrounded by the main portion 11 for inserting into a mating portion (not shown), and a connecting portion 13 located behind the main portion 13. The inner molding 2 is made of plastic material and molded on the connecting portion 13. The inner molding 2 defines a longer front portion 21, a shorter rear portion 23 and a groove 22 between the front portion 21 and the rear portion 23. The front portion 21 is truncated cone shaped. The diameter of a front end of the front portion 21 is biggest, and the diameter of a rear end of the front portion 21 is smallest. The diameter of the front portion 21 becomes smaller and smaller along the front end to the rear end of the front portion 21. The diameter of the rear portion 23 is equal to or less than the diameter of the rear end of the front portion 21. The groove 22 separates the front portion 21 from the rear portion 23.

The outer cover 3 is made of hard plastic material and molded. An outer surface of the outer cover 3 is cylinder and smooth. The outer cover 3 defines a rear wall 33, a receiving room 31 recessing rearwardly from a front end thereof and a through hole 32 recessing forwardly from the rear wall 33 and communicating with the receiving room 31. The diameter of the front end of the receiving room 31 is bigger than the diameter of the rear end of the receiving room 31. The length of the receiving room 31 is longer than the length of the front portion 21 of the inner portion 2. The diameter of the front end of the receiving room 31 is equal to the diameter of the connecting portion 13. The diameter of a point which is in the receiving room 31 is equal to the diameter of the front end of the front portion 21. In other embodiments, the diameter of the front end of the receiving room 31 is equal to the diameter of the front end of the front portion 21. The length of the receiving room 31 is equal to the length of the front portion 21 of the inner portion 2.

The outer molding 4 is cylinder and made of plastic material. The outer molding 4 has a front wall 41 received in the groove 22. The cable 5 has a number of wires (not shown).

In assembling, the wires are electrically connected to the pin 12 and the main portion 11 of the mating portion 1, respectively. The inner molding 2 is molded on the rear end of the connecting portion 13 and the front end of the cable 5. The outer cover 3 is assembled on the front portion 21 along a rear-to-front direction. The front portion 21 is received in the receiving room 31. The outer cover 3 completely encloses the front portion 21 of the inner molding 2. The rear wall 33 is attached to the rear surface of the front portion 21 and received in the groove 22. The connecting portion 13 is enclosed in the front of the receiving room 31. In other embodiments, the front end of the receiving room 31 only encloses the front end of the front portion of the inner molding 2. The outer molding 4 is molded on the rear portion 23 and the cable 5. The outer surface of the outer cover 3 is alignment to the outer surface of the outer molding 4. The front wall 41 is received in the groove 22 and attached to the rear wall 33 of the outer cover 3 for preventing the outer cover 3 moving. The outer molding 4 also become a relief strain portion of the cable 5 for protecting the cable 5.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An electrical connector, comprising:
a mating portion;
a cable electrically connected to the mating portion;
an inner molding molded on a rear end of the mating portion and a front end of the cable and defining a front portion located on a front end thereof, a rear portion located on a rear end thereof and a groove between the front portion and the rear portion;
an outer cover assembled on the inner molding and enclosing the front portion of the inner molding; and
an outer molding enclosing the rear portion of the inner molding and attached to the outer cover.

2. The electrical connector as recited in claim 1, wherein the outer cover has a rear wall received in the groove, a receiving room recessing rearwardly from a front surface thereof and a through hole recessing forwardly from the rear wall and communicating with the receiving room.

3. The electrical connector as recited in claim 2, wherein the rear wall is attached to a rear surface of the front portion.

4. The electrical connector as recited in claim 3, wherein the front portion is truncated cone, and the diameter of a front end of the receiving room is biggest.

5. The electrical connector as recited in claim 1, wherein the outer molding has a front wall received in the groove.

6. The electrical connector as recited in claim 5, wherein the outer surface of the outer cover is alignment to the outer surface of the outer molding.

7. The electrical connector as recited in claim 6, wherein the mating portion comprises a main portion, a pin surrounded the main portion and a connecting portion located behind the main portion.

8. The electrical connector as recited in claim 7, wherein the outer cover receives the rear end of the connecting portion.

9. The electrical connector as recited in claim 1, wherein the outer cover is assembled on the inner molding along rear-to-front direction.

10. An electrical connector, comprising:
a mating portion defining a main portion, a pin surrounded and electrically insulated the main portion and a connecting portion located behind the main portion;
a cable defining a number of wires electrically connected to the main portion and the pin, respectively;
an inner molding molded on the connecting portion and having a front portion which is truncated cone shaped;
an outer cover having a receiving room enclosing the front portion;
an outer molding molded on the cable and attached to the outer cover.

11. The electrical connector as recited in claim 10, wherein the inner molding also defines a rear portion located behind the front portion and a groove separating the front portion and the rear portion.

12. The electrical connector as recited in claim 11, wherein the outer cover has a rear wall receiving in groove.

13. The electrical connector as recited in claim 12, wherein the outer inner molding has a front wall attached to the rear wall.

14. The electrical connector as recited in claim 10, wherein the diameter of the front portion becomes smaller and smaller along a front-to-rear direction of the front portion.

15. An electrical connector comprising:
a metallic mating section;
an insulative inner molding attached to a rear side of the mating section and defining a front section with a backward truncated cone configuration thereof, and a rear section behind the front section in a front-to-back direction;
a cable rearwardly extending from a rear end of the rear section of the inner molding;
an outer cover circumferentially and intimately enclosing the front section with a first round columnar contour in a straight manner; and
an outer molding circumferentially and intimately enclosing the rear section with a second round columnar contour in the straight manner; wherein
the outer cover is materially harder than the outer molding.

16. The electrical connector as claimed in claim 15, wherein the contours of both the outer molding and the outer cover are coplanar with each other.

17. The electrical connector as claimed in claim 15, wherein a circumferential groove is formed between the front section and the rear section into which both the outer cover and the outer molding extend radially for preventing axial movement relative to the inner molding.

18. The electrical connector as claimed in claim 15, wherein the outer cover and the outer molding intimately abut against each other axially.

19. The electrical connector as claimed in claim 15, wherein said rear section is of a round columnar configuration.

20. The electrical connector as claimed in claim 15, wherein a rear end of the outer molding inwardly extends to directly radially contact the cable and axially seals a rear end of the rear section.
